(19) United States
(12) Patent Application Publication
(10) Pub. No.: US 2026/0329092 A1
(43) Pub. Date: Oct. 22, 2026

(54) Hardware Unit, System, Method, and Computer Program for Determining a Component Origin of a Head-Mounted Display in a Real Space

(71) Applicant: Karl Leibinger Asset Management GmbH & Co. KG, Mühlheim an der Donau (DE)

(72) Inventor: Stefan Schaffelhofer, Pregarten (AT)

(21) Appl. No.: 19/644,803

(22) Filed: Apr. 10, 2026

(30) Foreign Application Priority Data
Apr. 17, 2025 (DE) 102025115186.5

(51) Int. Cl. G02B 27/01; G02B 27/00; G06F 3/01; G06T 7/80

(52) U.S. Cl. CPC G02B 27/0172; G02B 27/0093; G02B 27/0176; G06F 3/013; G06T 7/80; G02B 2027/0138; G02B 2027/014; G02B 2027/0161; G06T 2207/10012; G06T 2207/10048

(57) ABSTRACT

A hardware unit (10) for determining a component origin of a head-mounted display (4) in a real space includes an internal image capturing device (6) and at least three markers (7) arranged on the head-mounted display (4) in a non-collinear manner. The hardware unit (10) includes a first interface (1) to the internal image capturing device (6) and a second interface (2) to an image capturing device (5). A computing device (3) is configured to determine the component origin of the head-mounted display (4) based on captures from the internal image capturing device (6), the external image capturing device (5), and the external image capturing device (5). The hardware unit (10) is configured to depict representations known in real space in a field of view of the head-mounted display (4) based on the determined component origin of the head-mounted display (4).

### CROSS-REFERENCE TO RELATED APPLICATION

The present application is related and has right of priority to German Patent Application No. DE 102025115186.5 filed on Apr. 17, 2025, which is incorporated by reference in its entirety for all purposes.

### TECHNICAL FIELD

The invention relates generally to the use of systems and methods of virtual reality (VR) and/or augmented reality (AR), in particular in the field of medicine. Moreover, the invention relates generally to a hardware unit, a system, a method, and a computer program, each for determining a component origin of a head-mounted display in a real space.

### BACKGROUND

Augmented reality is a technology that overlays digital information, such as images, graphics, or data onto the real physical world, in particular in real time. The overlays are shown in display devices in which real world and virtual world are combined in a common display. One example of such a display device is a head-mounted display. A head-mounted display is a display device which can be worn on the head and which displays information in front of the eyes of the user. A specific type of head-mounted display, and also encompassed by the term head-mounted display, are virtual reality glasses, which generate virtual environments and offer the user an immersive experience. Head-mounted displays are not limited to virtual reality. Head-mounted display also encompasses augmented reality display devices, which overlay digital, virtual information from the user point of view onto the real world. Augmented reality display devices are augmented reality glasses, for example, i.e. smart glasses, in which digital information is displayed to the user having been overlaid on their view of the real world. Known head-mounted displays are, for example, Oculus Quest, HTC Vive Pro Magic Leap, or Microsoft HoloLens. The known head-mounted displays can determine their position and orientation in real space by so-called inside-out tracking using internal sensors of the head-mounted display, for example by LiDAR sensors or gyroscopes.

Augmented reality improves the user experience of reality by adding computer-generated elements to their environment. In medical applications, augmented reality is used, for example, to offer improved visualization to healthcare professionals or surgeons during diagnostics and surgical procedures. For example, augmented reality is used in surgical navigation to obtain preoperative data, for example in the form of models of the patient anatomy, for example three-dimensional models, on the basis of computed tomography or magnetic resonance tomography. This enables the internal and external anatomy of the patient to be displayed for planning or to be overlaid on the living/real patient during the operation, for example. Examples of applications are operations on the human brain or knee operations.

In order to ensure that the overlays are precisely positioned in relation to real objects, parameters of the display device, for example relating to the orientation relative to a user, must be precisely determined.

US 2017/0092235 A1 lies in the field of computer games and discloses methods for optimizing the positioning of content on a display of a head-mounted display in order to transmit contents of video games to the head-mounted display of a user. To describe the position of the heat-mounted display, this can be tracked by an external camera by so-called outside-in tracking. To describe the orientation of the head-mounted display, the position of a reference object can be determined.

Coordinate systems are essential for determining position and orientation and for tracking the movement of head-mounted displays in order to correctly depict and overlay virtual contents and real objects. The origin of the head-mounted display in a fixed, global coordinate system can relate, in a three-dimensional Cartesian coordinate system, to the point (0, 0, 0) in virtual space, also referred to as the internal origin. The internal origin is associated with internal hardware of the head-mounted display and is initially not determined from the outside, i.e. in real space. The eye origin can lie between the eyes of the user and depends on the individual eye position and/or eye anatomy. In real space, the origin of the head-mounted display can be a defined point in the component of the head-mounted display, also referred to as the component origin of the head-mounted display. Even when the internal origin and/or the eye origin is known, the component origin can therefore not be determined. Although, for example, the position of markers arranged on the head-mounted display, for example, light-emitting diodes or reflectors, for example infrared reflectors, can be determined by the external camera, the origin of the head-mounted display relative to the markers remains unknown. Manufacturers of head-mounted displays generally do not disclose the component origin of the head-mounted display. In this context, an imprecise positioning of the markers on the head-mounted display is also problematic.

In the field of medicine, it is also known to use systems and methods of augmented reality. For example, Suthau, Tim. (2006), 10.14279/depositonce-1432 discloses Augmented Reality—Positionsgenaue Einblendung räumlicher Informationen in einem See Through Head Mounted Display für die Medizin am Beispiel der Leberchirurgie [Augmented Reality—Positionally Accurate Superimposition of Spatial Information in a See Through Head Mounted Display for Medicine Using the Example of Liver Surgery]. Iqbal, Hisham and Rodriguez y Baena, Ferdinando (2022), 2022 IEEE/RSJ International Conference on Intelligent Robots and Systems, 10.1109/iros47612.2022.9982215, arXiv:2405.01999 [cs.RO], disclose a semi-automatic infrared calibration for augmented reality systems in surgery. These disclosures describe approaches for determining the orientation of the head-mounted display. However, these disclosures also do not provide a solution, neither individually nor in combination with one another, for determining the component origin of the head-mounted display in real space.

The positioning of a head-mounted display in the field of medicine differs considerably from the use in gaming, since, inter alia, maximum precision in the representation of the digital information, for example, image data from computed tomography or magnetic resonance tomography, zero-latency visualization, and the avoidance of image distortions are of primary importance in medical uses, for example in diagnostics or surgery. In gaming, inaccurate positioning, minimal latencies and distortions can be tolerated, provided the gaming experience works. In the field of medicine, for example, in diagnostics or surgery, this cannot be accepted, since inaccurate positioning, minimal latencies and distortions, for example during real-time data transmission from diagnostic systems or surgical robots, can be decisive for the success of the medical treatment.

### BRIEF SUMMARY

Example aspects of the invention assist with precisely determining an origin of a head-mounted display, for example, a head-mounted display equipped with markers, in a real space.

According to one example aspect, a hardware unit is configured to determine a component origin of a head-mounted display in a real space, for example in an operating room. The hardware unit is a technical device which performs specific functions; here, the determination of the component origin. According to one example aspect, the functions are performed in combination with software execution, for example, by the hardware unit itself. The hardware unit can include a processor, a processor system including a plurality of processors, or a system on chip. The processor or processors that the hardware unit can include are one or a plurality of central processor(s) (CPU) or graphics processing unit(s) (GPU) or integrated circuit(s) (IC), application-specific integrated circuit(s) (ASIC), field-programmable gate array(s) (FPGA), or other electronic components. The hardware unit can include input and output modules and memory modules. The memory modules can be non-volatile memory modules.

The head-mounted display includes a position detection device or a position detection unit. The position detection device or position detection unit acquires information about positions, arrangements, and/or orientations of objects in three-dimensional space. The position detection device or position detection unit is also referred to in the following as an internal image capturing device without limiting the general function of a position detection device or position detection unit. This means, the internal image capturing device is a position detection device or position detection unit and is designed to capture information about positions, arrangements, and/or orientations of objects in three-dimensional space. The internal image capturing device can include one or a plurality of imaging sensor(s) of an imaging technology, for example, camera, radar, or LiDAR. According to one example aspect, the internal image capturing device includes one or a plurality of camera(s) arranged on the head-mounted display. The camera can be a camera that provides depth information from captures, i.e. three-dimensional captures. For example, the camera is a time-of-flight camera, for example on the basis of infrared radiation. In order to obtain depth information, the internal image capturing device can be designed, according to one example aspect, as a stereo camera system including at least two cameras. Thus, depth information can be determined on the basis of typical two-dimensional captures. The internal image capturing device is designed, according to one example aspect, to determine contours or edges of a reference object. The internal image capturing device permits inside-out tracking.

The head-mounted display includes at least three markers arranged on the head-mounted display in a non-collinear manner. The markers can be passive or active optical markers. Passive optical markers can be detected by an external image capturing device via reflection of incident radiation, for example infrared radiation, but the passive markers do not emit any radiation themselves. Active optical markers emit radiation themselves. One example of active optical markers are light-emitting diodes, for example infrared light-emitting diodes. According to one example aspect, the markers can include radar markers or LiDAR markers, i.e. markers that are detected by a radar sensor or a LiDAR sensor. By the markers, the position and orientation of the head-mounted display can be determined in real space, for example by outside-in tracking. Non-collinear means that the markers do not lie on a straight line. According to one example aspect, the markers include passive infrared markers. One advantage of passive infrared markers is that these consume no energy and can be detected in the visible range without interferences.

The hardware unit includes a first interface to the internal image capturing device, wherein the hardware unit is designed to receive captures from the internal image capturing device via the first interface. Captures from an image capturing device include raw sensor data of a capture sensor, for example of an image sensor of the image capturing device or by an imager, for example a camera chip, for example a camera system on chip, preprocessed image data, for example denoised image data or color image data.

The hardware unit includes a second interface to an image capturing device which is external relative to the head-mounted display. The external image capturing device can include one or a plurality of imaging sensor(s) of an imaging technology, for example, camera, radar, or LiDAR. According to one example aspect, the external image capturing device includes one or a plurality of camera(s) arranged externally relative to the head-mounted display. The one camera provides, according to one example aspect, depth information from captures, i.e. the camera delivers three-dimensional captures. For example, the camera is a time-of-flight camera, for example on the basis of infrared. When at least two cameras are used, for example two cameras, each of which delivers two-dimensional images, the external image capturing device can also determine depth information on the basis of two-dimensional captures, for example by triangulation. According to one example aspect, the external image capturing device includes at least four, six, eight, or ten cameras. The cameras of the external image capturing device can be arranged in a plane, for example in an annular arrangement. The external image capturing device permits an outside-in tracking of the head-mounted display.

The hardware unit is designed to receive captures from the external image capturing device via the second interface.

The first interface and/or the second interface can each be an interface for transmitting image captures. The first interface and/or the second interface can each be a wired interface, including optical fiber cables, or a wireless interface, for example on the basis of WLAN, Bluetooth, or a further standard for data transmission via wireless technology.

The hardware unit includes a computing device. The computing device determines the component origin of the head-mounted display. The computing device is designed to process the captures from the internal and the external image capturing devices. The computing device determines the component origin of the head-mounted display on the basis of at least one capture from the internal image capturing device of a reference object in real space having a known component origin of the reference object, on the basis of at least one capture from the external image capturing device of the reference object, and on the basis of at least one capture from the external image capturing device of the markers of the head-mounted display.

The hardware unit is designed to depict representations which are known in real space in a field of view of the head-mounted display on the basis of the determined component origin of the head-mounted display. Representations known in real space include representations of objects, for example instruments, for example surgical instruments, and of persons, wherein all positions and/or orientations of the objects and persons in real space are known. The representation in the field of view of the head-mounted display is created using projections, according to one example aspect on the basis of coordinate transformations, according to one example aspect by performing coordinate transformations in succession. According to one example aspect, the coordinate transformations are the first, the second, the third, and the fourth transformations disclosed below.

According to one example aspect, the computing device determines a first transformation between an internal coordinate system of the head-mounted display and a coordinate system of the reference object on the basis of at least one of the captures from the internal image capturing device of the reference object in real space having a known component origin. On the basis of the capture, the position and orientation of the reference object in the internal coordinate system of the head-mounted display are determined. The transformation is calculated on the basis of the capture from the internal image capturing device. For example, coordinates of the reference object in the internal coordinate system of the head-mounted display are determined. On the basis of the first transformation, the computing device transforms the internal coordinate system of the head-mounted display into the coordinate system of the reference object. Thus, the internal origin of the head-mounted display in the coordinate system of the reference object is known.

The reference object is arranged in real space in such a way that the reference object can be detected by the internal image capturing device and the external image capturing device, according to one example aspect at the same capture time or in the same capture window. The reference object acts as a common reference point between the internal coordinate system of the head-mounted display and a coordinate system of the external image capturing device. The reference object can be any component, tool, or device. At least three visually detectable features of the reference object, for example the component, the tool, or the device, can be used in order to detect the reference object three-dimensionally with respect to position and/or orientation. According to one example aspect, the reference object includes pattern-based markers, for example two-dimensional gratings, or optical markers, for example infrared reflective surfaces. According to one example aspect, the reference object is hand-held by a user of the head-mounted display. According to one example aspect, the reference object is fixedly arranged, for example on a stand. According to one example aspect, the reference object includes at least three non-collinearly arranged markers, for example passive infrared markers, the positions of which relative to the component origin of the reference object in the coordinate system of the reference object are known. The component origin of the reference object can be the coordinate origin of the coordinate system of the reference object. With a reference object having at least three non-collinearly arranged markers, one capture suffices to calculate the first transformation. With a reference object having fewer than three non-collinearly arranged markers, a plurality of captures from the reference object, each having a different arrangement of the reference object in real space, is required to calculate the first transformation.

According to one example aspect, the first transformation, according to a further example aspect thus also the second, the third, and/or the fourth transformation(s), are each a rigid transformation. Distances and angles are invariant under a rigid transformation. This allows image distortions to be avoided. A rigid transformation in three-dimensional space has three rotational degrees of freedom, for example, the Euler angle, and three translational degrees of freedom. Each marker, i.e. each point, delivers three equations. With three non-collinearly arranged points, an unambiguous solution for the transformation can be determined, in particular conditions for the rotation matrix are met. The transformation can be obtained in three-dimensional Cartesian coordinates in the form of a rotation matrix and translation matrix. According to one example aspect, the transformation is obtained in homogeneous coordinates as a 4×4 homogeneous matrix in which the rotation is in the upper left 3×3 block and the translation is in the last column of the first three rows, and in which the lowermost row is equal to [0 0 0 1]. According to one example aspect, the rotation in three-dimensional space is expressed by unit quaternions: q=q₀+q₁i+q₂j+q₃k with real numbers qᵢ and basis of the quaternions using the real numbers 1, i, j, k. The preceding comments apply for each of the first, the second, the third, and/or the fourth transformation(s). The first, the second, the third, and/or the fourth transformation(s) can also be projective transformations.

On the basis of at least one of the captures from the external image capturing device of the reference object, the computing device determines a second transformation between the coordinate system of the reference object and a coordinate system of the external image capturing device. The coordinate system of the external image capturing device can have a camera of the external image capturing device as the reference point, for example as the coordinate origin. On the basis of the capture, the position and orientation of the reference object in the coordinate system of the external image capturing device are determined. The transformation is calculated on the basis of the capture from the external image capturing device. For example, coordinates of the reference object in the coordinate system of the external image capturing device are determined. Since the component origin of the reference object in the coordinate system of the reference object is known, the component origin of the reference object in the coordinate system of the external image capturing device is obtained by the second transformation. On the basis of the second transformation, the computing device transforms an internal origin of the head-mounted display from the coordinate system of the reference object into the coordinate system of the external image capturing device.

On the basis of at least one of the captures from the external image capturing device of the markers of the head-mounted display, the computing device determines a third transformation between the coordinate system of the external image capturing device and a coordinate system of the head-mounted display defined by the markers. On the basis of the capture, the position and orientation of the markers in the coordinate system of the external image capturing device are determined. Since the computing device has also transformed the internal origin of the head-mounted display into the coordinate system of the external image capturing device, the internal origin of the head-mounted display and the positions and orientations of the markers of the head-mounted display are given in the coordinate system of the external image capturing device. This means, the internal origin of the head-mounted display and the positions and orientations of the markers of the head-mounted display are given in a common, identical coordinate system.

The computing device determines the component origin of the head-mounted display by carrying out the third transformation. The computing device transforms the internal origin of the head-mounted display from the coordinate system of the external image capturing device into the coordinate system of the head-mounted display defined by the markers. The internal origin of the head-mounted display, which has been transformed in such a way into the coordinate system of the head-mounted display defined by the markers, acts as the component origin of the head-mounted display.

The hardware unit is designed to depict representations which are known in real space in a field of view of the head-mounted display on the basis of the determined component origin of the head-mounted display. Thus, the component origin of the head-mounted display is known as the reference point for representations in the head-mounted display. Thus, digital information including virtual representations and/or virtual objects can be overlaid, having been positioned in a highly accurate manner relative to real representations and/or real objects in real space and the augmented reality can be more accurately represented in the field of view of a user of the head-mounted display.

According to one example aspect, the computing device has sufficiently high computing and memory capacities and has sufficiently short cycle times. Thus, the computing device can process and calculate the tracking data and further image information and thus the first, the second, and the third transformations in real time. According to one example aspect, the computing device is a high-performance computer. Thus, zero-latency visualizations are achieved in the field of view of the head-mounted display.

For depicting in the field of view of the head-mounted display, the hardware unit includes, according to a further example aspect, a third interface to an optical device of the head-mounted display. The third interface is advantageously designed for fast data transmission with minimal latency. The optical device depicts the representations in the field of view of the user. For example, the optical device transforms the representations in front of the eyes of the user. According to one example aspect, the optical device is a virtual retinal display. In a virtual retinal display, the corresponding representation is projected directly onto the retina of the user with the aid of weak laser beams, i.e. laser beams that do not damage the retina of the user. The real world can also be seen at the same time. The hardware unit is designed to provide the representations known in real space transformed accordingly by carrying out the first, the second, the third, and the fourth transformations via the third interface to the optical device of the head-mounted display. Thus, the required transformations can be carried out outside of the optical device of the head-mounted display and outside of the head-mounted display. For example, the computing device has sufficiently high computing and memory capacities and has sufficiently short cycle times. Thus, zero-latency visualizations are achieved in the field of view of the head-mounted display.

According to a further example aspect, the invention provides a system for determining a component origin of a head-mounted display in a real space. For the individual components of the system, the preceding comments regarding the corresponding components of the hardware unit apply. The system includes the head-mounted display. The head-mounted display includes an internal image capturing device and at least three markers arranged on the head-mounted display in a non-collinear manner. The system also includes an external image capturing device which is arranged separately from the head-mounted display. The system also includes a reference object having a known component origin. The reference object is arrangeable in real space in such a way that the reference object is perceptible by the internal image capturing device and the external image capturing device. The system also includes a hardware unit. The hardware unit is designed to determine the component origin of the head-mounted display on the basis of captures from the internal image capturing device of the reference object, on the basis of captures from the external image capturing device of the reference object, and on the basis of captures from the external image capturing device of the markers of the head-mounted display, and to depict representations known in real space in a field of view of the head-mounted display on the basis of the determined component origin of the head-mounted display.

According to one example aspect, the hardware unit is designed to
determine a first transformation between the internal coordinate system of the head-mounted display and a coordinate system of the reference object on the basis of at least one of the captures from the internal image capturing device of the reference object, wherein the position and orientation of the reference object in an internal coordinate system of the head-mounted display are determined on the basis of the capture, and to transform the internal coordinate system of the head-mounted display into the coordinate system of the reference object;
determine a second transformation between the coordinate system of the reference object and the coordinate system of the external image capturing device on the basis of at least one of the captures from the external image capturing device of the reference object, wherein the position and orientation of the reference object in a coordinate system of the external image capturing device are determined on the basis of the capture, and to transform an internal origin of the head-mounted display from the coordinate system of the reference object into the coordinate system of the external image capturing device;
determine a third transformation between the coordinate system of the external image capturing device and a coordinate system of the head-mounted display defined by the markers on the basis of at least one of the captures from the external image capturing device of the markers of the head-mounted display, wherein the position and orientation of the markers in the coordinate system of the external image capturing device are determined on the basis of the capture;
by carrying out the third transformation, determine the component origin of the head-mounted display by transformation of the internal origin of the head-mounted display from the coordinate system of the external image capturing device into the coordinate system of the head-mounted display defined by the markers.

According to one example aspect, the hardware unit of the system is a hardware unit as disclosed above. For example, the computing device includes a high-performance computer. This means, the hardware unit disclosed here is integrated into the system. According to one example aspect, the hardware unit is integrated into the external image capturing device.

According to a further example aspect, in the system, the external image capturing device includes at least two cameras, for example two active infrared cameras delivering depth information. Thus, the external image capturing device obtains three-dimensional captures of the reference object and of the markers of the head-mounted display. According to one example aspect, the external image capturing device includes a plurality of cameras, for example a plurality of active infrared cameras delivering depth information, for example four, six, eight, ten or more. The cameras are, according to one example aspect, circular, annular, elliptical, or polygonal.

According to one example aspect, the markers arranged on the head-mounted display are passive infrared markers. Thus, the head-mounted display can be detected by the external image capturing device with infrared cameras.

According to a further example aspect, the reference object includes at least three non-collinearly arranged markers, for example, active and/or passive infrared markers, and/or the reference object includes at least three visually detectable features. On the basis of the visual features, the reference object can be detected in the coordinate system of the head-mounted display. The visual features can be certain shapes, edges, or contours, for example. According to one example aspect, the visual features are determined by executing algorithms from the field of computer vision, according to one example aspect by algorithms from the field of machine learning.

For example, the head-mounted display and the external image capturing device each detect the markers on the reference object, for example by cameras.

In a further example, the head-mounted display and the external image capturing device each detect visual features on the reference object, for example by cameras.

In a further exemplary embodiment, the reference object includes the non-collinearly arranged markers and the visually detectable features. For example, the head-mounted display detects the visual features on the reference object, for example by cameras. For example, the external image capturing device detects the markers on the reference object.

According to a further example aspect, the invention provides a system for determining a component origin of a head-mounted display in a real space. In method steps, the component origin is determined on the basis of captures from an internal image capturing device of the head-mounted display of a reference object in real space, on the basis of captures from an external image capturing device of the reference object, and on the basis of captures from the external image capturing device of markers of the head-mounted display. Representations known in real space are depicted in a field of view of the head-mounted display on the basis of the determined component origin of the head-mounted display.

According to one example aspect, the method is computer implemented. According to one example aspect, the hardware unit disclosed here or the system disclosed here is used to carry out the method, for example to obtain the captures and to determine coordinate transformations. Thus, an end-to-end solution is provided in which the hardware unit disclosed here is integrated into the system disclosed here, according to one example aspect into the external image capturing device, and the hardware unit executes the method disclosed here.

According to one example aspect, the method includes the following method steps:
determining a first transformation between the internal coordinate system of the head-mounted display and a coordinate system of the reference object on the basis of at least one of the captures from the internal image capturing device of the reference object in real space having a known component origin, wherein the position and orientation of the reference object in an internal coordinate system of the head-mounted display are determined on the basis of the capture;
transforming the internal coordinate system of the head-mounted display into the coordinate system of the reference object by the first transformation;
determining a second transformation between the coordinate system of the reference object and the coordinate system of the external image capturing device on the basis of at least one of the captures from the external image capturing device of the reference object, wherein the position and orientation of the reference object in a coordinate system of the external image capturing device are determined on the basis of the capture;
transforming an internal origin of the head-mounted display from the coordinate system of the reference object into the coordinate system of the external image capturing device by the second transformation;
determining a third transformation between the coordinate system of the external image capturing device and a coordinate system of the head-mounted display defined by the markers on the basis of at least one of the captures from the external image capturing device of the markers of the head-mounted display, wherein the position and orientation of the markers in the coordinate system of the external image capturing device are determined on the basis of the capture;
by carrying out the third transformation, determining the component origin of the head-mounted display by transformation of the internal origin of the head-mounted display from the coordinate system of the external image capturing device into the coordinate system of the head-mounted display defined by the markers.

The aforementioned method steps are carried out, according to one example aspect, by internal process steps of the computing device disclosed here. The preceding disclosures regarding the transformations and further components apply correspondingly for these method steps.

The method is carried out, according to one example aspect, at a point in time, i.e. by a frame of the internal and the external image capturing devices. According to another example aspect, the method is carried out over a longer time period, wherein an average of various assumed perspectives can be calculated in order to minimize measuring errors or the noise.

According to one example aspect, the component origin of the head-mounted display is scaled and/or positioned with respect to the individual eye position of a user of the head-mounted display. Scaling includes depicting a point in the field of view of the head-mounted display as being larger or smaller, for example in the virtual environment, than it really is. For example, a point on a screen in real space is only a few millimeters in size, but when the user gazes at the point through the head-mounted display, it can appear to be ten centimeters in size, for example. Positioning includes bringing a point in the field of view of the head-mounted display to a certain position in the virtual environment.

The component origin of the head-mounted display is initially determined in a user-neutral manner. Due to the user-specific eye position or anatomy of the eyes, however, deviations can still arise between the representations in the head-mounted display, for example in the form of a hologram, and reality. Due to these deviations, scaling errors and/or positioning errors can occur. Even though such deviations are minor and are tolerable in gaming, they are undesired in medical applications. These deviations are eliminated, at least reduced to an acceptable level, due to the scaling and/or positioning of the component origin of the head-mounted display with respect to the individual eye position of the user.

According to one example aspect, in order to scale and/or position the component origin of the head-mounted display with respect to the individual eye position of the user, the following method steps are carried out in interaction with the user: In one method step, the user gazes at the centers of markers of a reference object arranged in real space. The reference object, according to one example aspect, is the reference object disclosed here. According to one example aspect, the reference object includes at least three, for example four, non-collinearly arranged markers, the positions and/or orientations of which relative to a known component origin of the reference object are known. According to one example aspect, the user is prompted via the display of the head-mounted display or via an audio device, for example including at least one loudspeaker, of the head-mounted display to sequentially gaze at the centers of the markers, for example three markers, for example in a plurality of repetitions. During this sequential gazing, the respective focal point of the user is recorded. Thus, intrinsic and extrinsic parameters, including scaling of the eyes, are determined. These method steps are repeated, for example sequentially repeated, according to one example aspect, for as long as it takes until an overlay of objects in real space with the augmented reality, which is displayed in the head-mounted display, is sufficiently precise. During the execution of these method steps, according to one example aspect, the user is prompted to gaze at the reference object from different positions assumed in real space, which improves accuracy.

Thus, a corresponding fourth transformation is obtained. According to one example aspect, a point-set registration is carried out to determine the fourth transformation. A point-set registration is a method for checking and/or correcting two or more three-dimensional point sets with the goal of obtaining a mutual correspondence of the points. According to one example aspect, this fourth transformation for the user is stored, for example, in a user profile. Thus, the fourth transformation for the user needs to be determined only once. According to one example aspect, the user profile is stored in a memory of the hardware unit disclosed here.

According to one example aspect, the invention provides a computer program for determining a component origin of a head-mounted display in a real space. The computer program includes program commands, for example in a hardware-oriented programming language such as C or a higher programming language, for example an object-oriented programming language such as C++ or Java. The program commands cause a computer to execute the steps of the method disclosed here when the computer loads or runs the computer program. According to one example aspect, the computer is a computer of the system disclosed here. According to one example aspect, the computer is the hardware unit disclosed here. Thus, an end-to-end solution is provided, in which the hardware components, i.e. the hardware unit and the system, interact with the software, i.e. the computer program.

### BRIEF DESCRIPTION OF THE DRAWINGS

Exemplary embodiments of the invention are described in detail with reference to the figures, wherein:

FIG. 1 shows an exemplary embodiment of a hardware unit disclosed here,

FIG. 2 shows an exemplary embodiment of a system disclosed here,

FIG. 3 shows an exemplary embodiment of a reference object disclosed here,

FIG. 4 shows an exemplary embodiment of a system, which is disclosed here, in an application, which is disclosed here, of the method disclosed here,

FIG. 5 shows a flowchart of an exemplary embodiment of a method disclosed here,

FIG. 6 shows an exemplary embodiment of a scaling and/or positioning, which is disclosed here, of a head-mounted display, which is disclosed here, with respect to the individual eye position of a user, and

FIG. 7a to FIG. 7d show exemplary steps related to the scaling and/or positioning, which is disclosed here, of a head-mounted display, which is disclosed here, with respect to the individual eye position of a user.

In the figures, the same reference numbers designate identical or functionally similar reference parts. For the sake of clarity, only the reference parts that are relevant to the understanding of the respective figure may be labeled in the individual figures.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

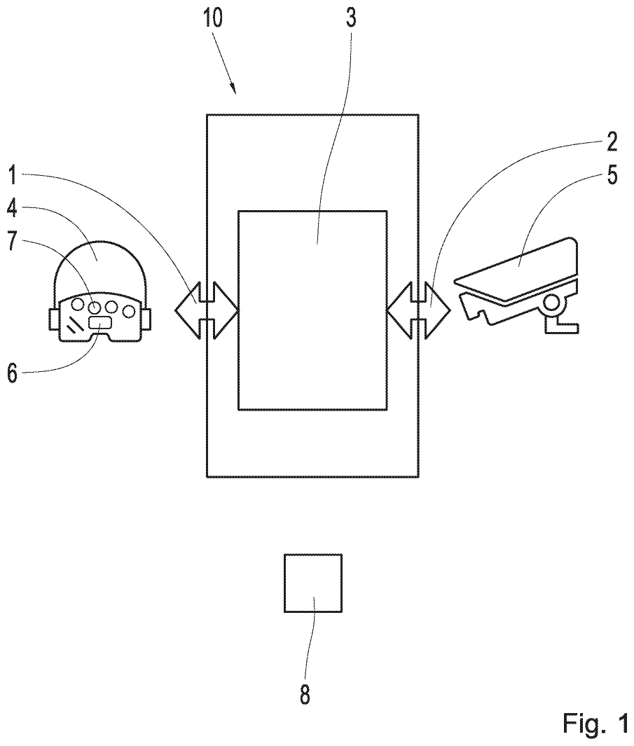

FIG. 1 shows an exemplary embodiment of the hardware unit 10 disclosed here. The hardware unit 10 is designed to determine a component origin of a head-mounted display 4 in a real space.

The head-mounted display 4 is, for example, augmented reality glasses worn on a head of a user 30. The head-mounted display 4 includes an internal image capturing device 6. The internal image capturing device 6 is, for example, an active infrared camera of the head-mounted display, which provides depth information, for example by time-of-flight technology. In addition, the head-mounted display 4 includes at least three markers 7 arranged on the head-mounted display 7 in a non-collinear manner. In FIG. 1, four markers 7 are arranged on the head-mounted display 4. The markers 7 are each passive infrared reflectors, for example.

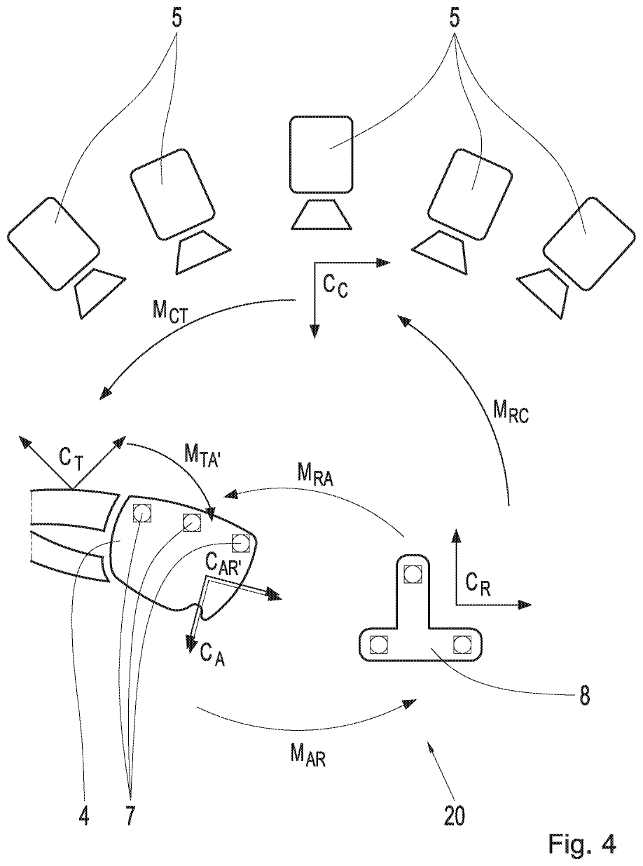

The hardware unit 10 includes a first interface 1 to the internal image capturing device 6. The first interface 1 is, for example, a data interface, via which a computing device 3 of the hardware unit 10 obtains captures from the internal image capturing device 6 for further processing. The hardware unit 10 also includes a second interface 2 to an image capturing device 5 which is external relative to the head-mounted display 4. The external image capturing device 5 is, for example, a system of a plurality of active infrared cameras, for example four, six, eight, ten or more, of which a few are shown, in sections, in FIG. 4. The infrared cameras can detect infrared markers, for example the markers 7 of the head-mounted display 4 and the markers 9 of the reference object 8. Via the second interface 2, the hardware unit 10 receives captures from the external image capturing device 5. The second interface 2 is designed, for example, as a data interface.

The hardware unit 10 also includes a computing device 3. The computing device 3 is, for example, a high-performance computer. The computing unit 3 is designed to determine the component origin of the head-mounted display 4 on the basis of captures from the internal image capturing device 6 of the reference object 8 in real space having a known component origin, on the basis of captures from the external image capturing device 5 of the reference object 8, and on the basis of captures from the external image capturing device 5 of the markers 7 of the head-mounted display 4.

The hardware unit 10 is designed to depict representations which are known in real space in a field of view of the head-mounted display 5 on the basis of the determined component origin of the head-mounted display 4.

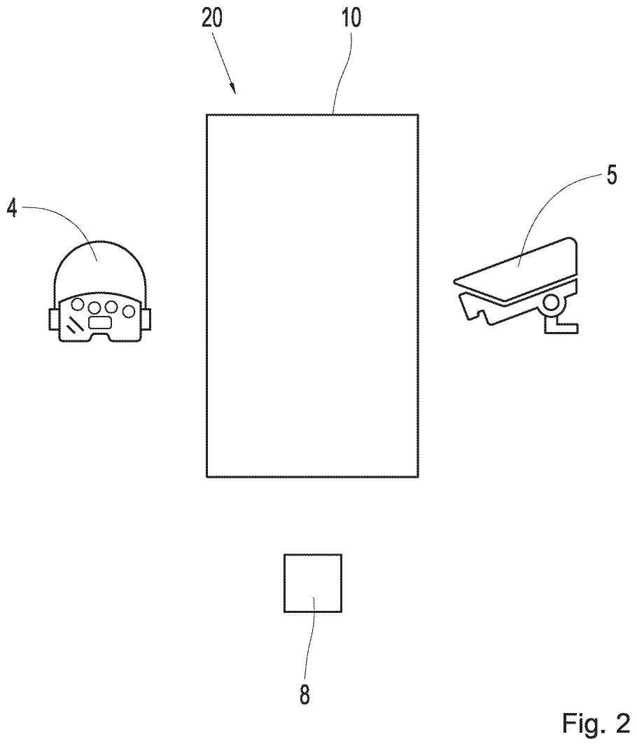

FIG. 2 shows an exemplary embodiment of the system 20 disclosed here. The hardware unit 10, for example as shown in FIG. 1, is integrated into the system 20, for example. The system 20 also includes the head-mounted display 4 and the external image capturing device 5. The reference object 8 is arranged in such a way that the reference object 8 lies both in a capture area of the internal image capturing device 6 and in a capture area of the external image capturing device 5.

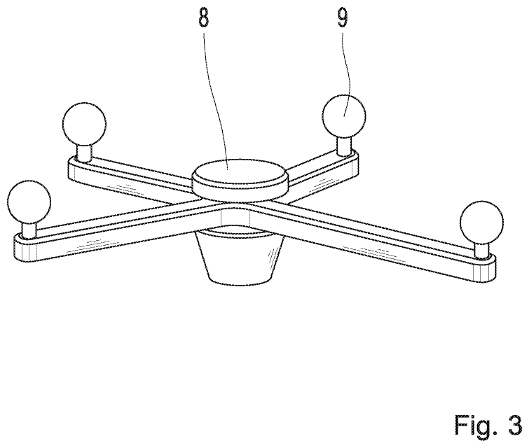

FIG. 3 shows an exemplary embodiment of a reference object 8. The reference object 8 includes, for example, four markers 9 arranged in a non-collinear manner. The markers 9 are passive infrared reflectors, for example. The component origin of the reference object 8 and the positions of the markers 9 relative to this component origin are known, for example in a component-fixed coordinate system C_{R} of the reference object 8.

FIG. 4 shows the system 20 in an application, which is disclosed here, of the method, which is disclosed here, for determining the component origin of the head-mounted display 4 in real space. The coordinate systems of outside-in and inside-out tracking are shown. The head-mounted display 4, for example designed as augmented reality glasses, has an origin in its own internal coordinate system C_{A}. Via the reference object 8 in the coordinate system C_{R} of the reference object 8, wherein the reference object 8 is detected both by the internal tracking of the glasses, i.e. of the internal image capturing device 6, and by the external tracking, i.e. the external image capturing device 5, the origin of the glasses in the space of the external tracking system, i.e. in the coordinate system C_{C} can be determined. C_{C} is the coordinate system of the external image capturing device 5 and C_{T} is the coordinate system of the head-mounted display 4 defined by the markers 7 arranged on the head-mounted display 4. C_{AR′} is the coordinate system of the user 30, which is aligned with the individual eye position of the user 30.

M_{RA}, M_{AR} is the first transformation, which the computing device 3 determines on the basis, for example, of one of the captures from the internal image capturing device 6 of the markers 9 of the reference object 8 in real space. M_{RA} is, for example, a 4×4 matrix in homogeneous coordinates and M_{AR} is the inverse matrix thereof. The first transformation M_{RA}, M_{AR} is a transformation between the internal coordinate system C_{A} of the head-mounted display 4 and the coordinate system C_{R} of the reference object 8. By this transformation, the computing device 3 transforms the internal coordinate system C_{A} of the head-mounted display 4 into the coordinate system C_{R} of the reference object 8.

M_{RC} is the second transformation, which the computing device 3 determines on the basis, for example, of one of the captures from the external image capturing device 5 of the markers 9 of the reference object 8. The second transformation M_{RC} is a transformation between the coordinate system C_{R} of the reference object 8 and the coordinate system C_{C} of the external image capturing device 5. By this transformation, the computing device 3 transforms the internal origin of the head-mounted display 4 from the coordinate system C_{R} of the reference object 8 into the coordinate system C_{C} of the external image capturing device 5.

M_{CT} is the third transformation, which the computing device 3 determines on the basis, for example, of one of the captures from the external image capturing device 5 of the markers 7 of the head-mounted display 4. The third transformation M_{CT} is a transformation between the coordinate system C_{C} of the external image capturing device 5 and a coordinate system of the head-mounted display C_{T} defined by the markers 7. By carrying out the third transformation M_{CT}, the computing device 3 determines the component origin of the head-mounted display 4 by transformation of the internal origin of the head-mounted display 4 from the coordinate system C_{C} of the external image capturing device 5 into the coordinate system C_{T} of the head-mounted display 4 defined by the markers 7.

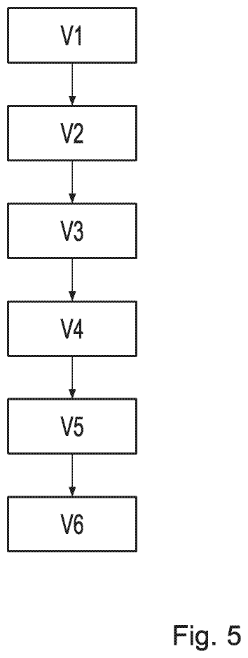

FIG. 5 schematically shows the sequence of an exemplary embodiment of the method disclosed here. The method is carried out, for example, with the system 20. The respective calculations are carried out in the computing device 3 of the hardware unit 10.

In a method step V1, the first transformation M_{RA}, M_{AR} between the internal coordinate system C_{A} of the head-mounted display 4 and the coordinate system C_{R} of the reference object 8 is determined on the basis of at least one of the captures from the internal image capturing device 6 of the reference object 8.

In a method step V2, the internal coordinate system C_{A} of the head-mounted display 4 is transformed into the coordinate system C_{R} of the reference object 8 by the first transformation M_{RA}, M_{AR}.

In a method step V3, the second transformation M_{RC} between the coordinate system C_{R} of the reference object 8 and the coordinate system C_{C} of the external image capturing device 5 is determined on the basis of at least one of the captures from the external image capturing device 5 of the reference object 8.

In a step V4, the internal origin of the head-mounted display 4 is transformed from the coordinate system C_{R} of the reference object 8 into the coordinate system C_{C} of the external image capturing device 5 by the second transformation M_{RC}. Due to the first transformation M_{RA}, M_{AR}, the internal origin of the head-mounted display 4 in the coordinate system C_{R} of the reference object 8 is known.

In a method step V5, the third transformation M_{CT} between the coordinate system C_{C} of the external image capturing device 5 and the coordinate system C_{T} of the head-mounted display 4 defined by the markers 7 is determined on the basis of at least one of the captures from the external image capturing device 5 of the markers 7 of the head-mounted display 4.

In a step V6, the component origin of the head-mounted display 4 is determined by transformation of the internal origin of the head-mounted display 4 from the coordinate system C_{C} of the external image capturing device 5 into the coordinate system C_{T} of the head-mounted display 4 defined by the markers 7 by carrying out the third transformation M_{CT}.

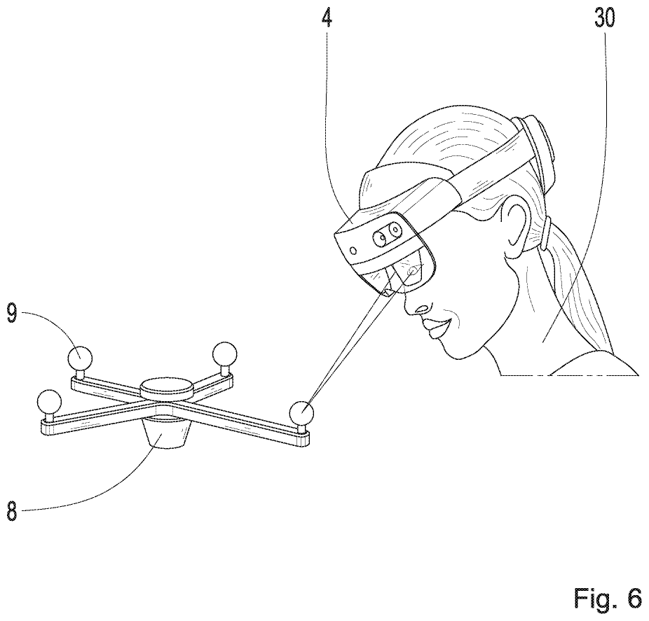

FIG. 6 shows an exemplary embodiment of a scaling and/or positioning, which is disclosed here, of the head-mounted display 4 with respect to the individual eye position of the user 30. In the method step V6 in FIG. 5, the component origin of the head-mounted display 4 is initially determined in a user-neutral manner. Due to user-specific eye positions, however, deviations can exist between hologram and reality. The scaling and/or position can still deviate.

A hologram is a virtual three-dimensional representation of an object or of a scene, which is depicted in real time and with high resolution. The representation can be a digital reconstruction of an object or of a scene, which is integrated directly into the field of view of the user 30. Holograms can be three-dimensional models of objects that are depicted in real time, or virtual environments that are depicted with high resolution and realism.

In order to at least reduce this deviation, in FIG. 6 the user 30 gazes at the real markers 9 of the reference object 8. The respective focal point is recorded, for example, by eye tracking. The fourth transformation M_{TA′} can be determined by at least three markers 9, which are arranged in a non-collinear manner.

Eye tracking is a method that measures and analyzes the movement and the state of the eyes of the user 30. It is used to obtain information about, for example, the focus of the user 30 on a certain representation or interaction. Eye tracking uses, for example, infrared radiation to measure the pupil movement or the interpupillary distance of the user 30.

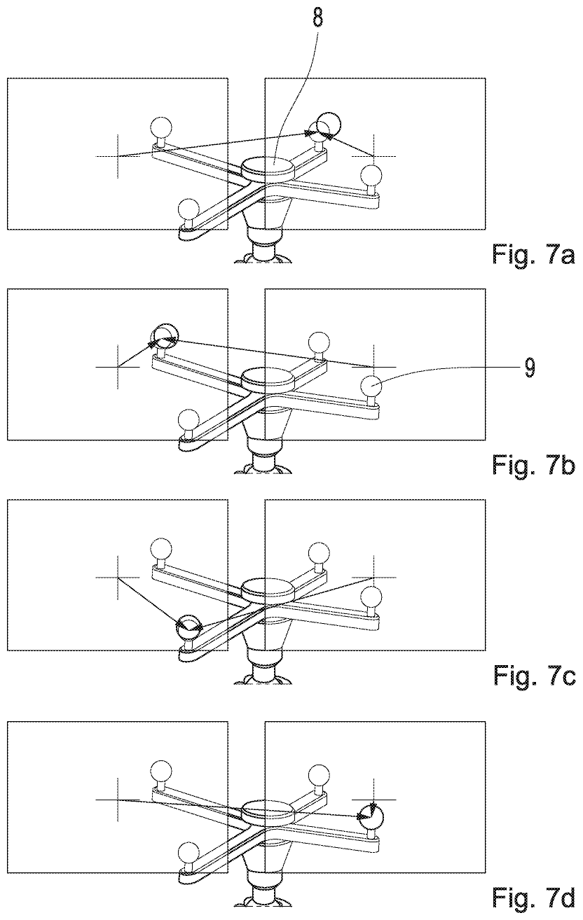

FIG. 7a through FIG. 7d show a sequence of, for example, four steps for determining the user-specific fourth transformation M_{TA′}. The rectangles shown indicate the field of view of the user 30 through the head-mounted display 4. The arrows in these rectangles reflect the eye tracking, which is not visible to the user 30. The crosshairs show the respective centers of the respective display. The overlaid circles are virtually superimposed circles that visualize the current overlay and act as quality features. The individual steps can each be repeated with at least three markers 9. An instruction to the user 30 could read, for example, as follows: “Gaze at the real marker that is visible closest to a large circle. Repeat this step until the superimposed circle precisely overlaps with the markers.”

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### LIST OF REFERENCE CHARACTERS

1 first interface
2 second interface
3 computing device
4 head-mounted display
5 external, second image capturing device
6 internal, first image capturing device
7 markers arranged on the head-mounted display
8 reference object
9 markers arranged on the reference object
10 hardware unit
20 system
30 user
C_{A} internal coordinate system of head-mounted display
C_{R} coordinate system of reference object
C_{C} coordinate system of external image capturing device
C_{T} coordinate system of the head-mounted display defined by the markers arranged on the head-mounted display
C_{AR′} coordinate system of use
M_{RA}, M_{AR} first transformation
M_{RC} second transformation
M_{CT} third transformation
M_{TA′} fourth transformation
V1-V6 method steps

1-11. (canceled)

12. A hardware unit (10) for determining a component origin of a head-mounted display (4) in a real space, the head-mounted display (4) comprising an internal image capturing device (6) and at least three markers (7) arranged on the head-mounted display (4) in a non-collinear manner, the hardware unit (10) comprising:
a first interface (1) to the internal image capturing device (6), the hardware unit (10) configured to receive captures from the internal image capturing device (6) via the first interface (1);
a second interface (2) to an image capturing device (5) that is external relative to the head-mounted display (4), the hardware unit (10) configured to receive captures from the external image capturing device (5) via the second interface (2); and
a computing device (3) configured to determine the component origin of the head-mounted display (4) based on captures from the internal image capturing device (6) of a reference object (8) in real space having a known component origin, from the external image capturing device (5) of the reference object (8), and from the external image capturing device (5) of the markers (7) of the head-mounted display (4),
wherein the hardware unit (10) is configured to depict representations known in real space in a field of view of the head-mounted display (4) based on the determined component origin of the head-mounted display (4).

13. The hardware unit (10) of claim 12, wherein the computing device (3) is configured to:
determine a first transformation (M_RA, M_AR) between the internal coordinate system (C_A) of the head-mounted display (4) and a coordinate system (C_R) of the reference object (8) based on at least one of the captures from the internal image capturing device (6) of the reference object (8) and transform the internal coordinate system (C_A) of the head-mounted display (4) into the coordinate system (C_R) of the reference object (8), wherein the position and orientation of the reference object (8) in the internal coordinate system (C_A) of the head-mounted display (4) are determined based on the at least one of the captures from the internal image capturing device (6) of the reference object (8); and
determine a second transformation (M_RC) between the coordinate system (C_R) of the reference object (8) and the coordinate system (C_C) of the external image capturing device (5) based on at least one of the captures from the external image capturing device (5) of the reference object (8) and transform an internal origin of the head-mounted display (4) from the coordinate system (C_R) of the reference object (8) into the coordinate system (C_C) of the external image capturing device (5), wherein the position and orientation of the reference object (8) in the coordinate system (C_C) of the external image capturing device (5) are determined based on the at least one of the captures from the external image capturing device (5) of the reference object (8); and
determine a third transformation (M_CT) between the coordinate system (C_C) of the external image capturing device (5) and a coordinate system (C_T) of the head-mounted (C_T) display (4) defined by the markers (7) based on at least one of the captures from the external image capturing device (5) of the markers (7) of the head-mounted display (4), wherein the position and orientation of the markers (7) in the coordinate system (C_C) of the external image capturing device (5) are determined based on the at least one of the captures from the external image capturing device (5) of the markers (7) of the head-mounted display (4); and
by carrying out the third transformation (M_CT), determine the component origin of the head-mounted display (4) by transformation of the internal origin of the head-mounted display (4) from the coordinate system (C_C) of the external image capturing device (5) into the coordinate system (C_T) of the head-mounted display (4) defined by the markers (7).

14. A system (20) for determining a component origin of a head-mounted display (4) in a real space, the system (20) comprising:
the head-mounted display (4) comprising a first image capturing device (6) and at least three markers (7) arranged on the head-mounted display (4) in a non-collinear manner;
a second image capturing device (5) arranged externally with respect to the head-mounted display (4);
a reference object (8) having a known component origin, arrangeable in real space such that the reference object (8) is perceptible by the first image capturing device (6) and the second image capturing device (5);
a hardware unit (10) configured to determine the component origin of the head-mounted display (4) based on captures from the first image capturing device (6) of the reference object (8), from the second image capturing device (5) of the reference object (8) and from the second image capturing device (5) of the markers (7) of the head-mounted display (4), the hardware unit (10) configured to depict representations known in real space in a field of view of the head-mounted display (4) based on the determined component origin of the head-mounted display (4).

15. The system (20) of claim 14, wherein the hardware unit (10) comprises:
a first interface (1) to the internal image capturing device (6), the hardware unit (10) configured to receive captures from the internal image capturing device (6) via the first interface (1);
a second interface (2) to an image capturing device (5) that is external relative to the head-mounted display (4), the hardware unit (10) configured to receive captures from the external image capturing device (5) via the second interface (2); and
a computing device (3) configured to determine the component origin of the head-mounted display (4).

16. The system (20) of claim 14, wherein the second image capturing device (5) comprises at least two cameras.

17. The system (20) of claim 14, wherein the markers (7) arranged on the head-mounted display (4) comprise passive infrared markers.

18. The system (20) of claim 14, wherein one or both of:
the reference object (8) comprises at least three markers (9) arranged non-collinearly; and
the reference object (8) comprises at least three visually detectable features.

19. A method for determining a component origin of a head-mounted display (4) in a real space, the method comprising:
determining the component origin based on
captures from a first image capturing device (6), which is associated with the head-mounted display (4), of a reference object (8) in real space,
captures from a second image capturing device (5), which is not associated with the head-mounted display (4), of the reference object (8), and
captures from the second image capturing device (5) of markers (7) of the head-mounted display (4); and
depicting representations known in real space in a field of view of the head-mounted display (4) based on the determined component origin of the head-mounted display (4).

20. The method of claim 19, the method further comprises:
determining a first transformation (M_RA, M_AR) between the internal coordinate system (C_A) of the head-mounted display (4) and a coordinate system (C_R) of the reference object (8) (V1) based at least one of the captures from the first image capturing device (6) of the reference object (8) in real space having a known origin, wherein the position and orientation of the reference object (8) in the internal coordinate system (C_A) of the head-mounted display (4) are determined based on the at least one of the captures from the first image capturing device (6) of the reference object (8);
transforming the internal coordinate system (C_A) of the head-mounted display (4) into the coordinate system (C_R) of the reference object (8) (V2);
determining a second transformation (M_RC) between the coordinate system (C_R) of the reference object (8) and the coordinate system (C_C) of the external image capturing device (5) (V3) based on at least one of the captures from the second external image capturing device (5) of the reference object (8), wherein the position and orientation of the reference object (8) in the coordinate system (C_C) of the second image capturing device (5) are determined based on the at least one of the captures from the second external image capturing device (5) of the reference object (8);
transforming an internal origin of the head-mounted (4) from the coordinate system (C_R) of the reference object (8) into the coordinate system (C_C) of the second image capturing device (5) (V4);
determining a third transformation (M_CT) between the coordinate system (C_C) of the external image capturing device (5) and a coordinate system (C_T) of the head-mounted display (4) defined by the markers (7) (V5) based on at least one of the captures from the second image capturing device (5) of the markers (7) of the head-mounted display (4), wherein the position and orientation of the markers (7) in the coordinate system (C_C) of the second image capturing device (5) are determined based on the at least one of the captures from the second image capturing device (5) of the markers (7) of the head-mounted display (4); and
by carrying out the third transformation (M_CT), determining the component origin of the head-mounted display (4) by transformation of the internal origin of the head-mounted display (4) from the coordinate system (C_C) of the second image capturing device (5) into the coordinate system (C_T) of the head-mounted display (4) defined by the markers (7) (V6).

21. The method of claim 19, wherein:
the component origin of the head-mounted display (4) is scaled and/or positioned with respect to an individual eye position of a user (30) of the head-mounted display (4) by prompting the user (30) to gaze at centers of the markers (9) of the reference object (8); and
during the gazing, the respective focal point of the user (30) is recorded and intrinsic and extrinsic parameters of the eyes are determined based on the recorded focal point.

22. A computer program for determining a component origin of a head-mounted display (4) in a real space, the computer program comprising program commands that prompt a computer to execute the method of claim 19 when the computer loads or runs the computer program.
